(19) United States
(12) Patent Application Publication
(10) Pub. No.: US 2011/0202307 A1
(43) Pub. Date: Aug. 18, 2011

(54) Method and System for Recognizing the Working Range of a Mobile Tool

(75) Inventors: Steffen Petereit, Freiberg A.N. (DE); Amos Albert, Leonberg (DE); Friederike Dietzel, Stuttgart (DE)

(73) Assignee: Robert Bosch GmbH, Stuttgart (DE)

(21) Appl. No.: 13/125,030

(22) PCT Filed: Oct. 12, 2009
(86) PCT No.: PCT/EP2009/063268

§ 371 Date: Apr. 19, 2011

(30) Foreign Application Priority Data
Oct. 20, 2008 (DE) 102008042948.1
Mar. 26, 2009 (DE) 1020090019006.26

(51) Int. Cl. G06F 15/00

(52) U.S. Cl. 702/150

(57) ABSTRACT

A method for recognizing the operating range of a mobile, autonomous implement, in which the operating range assigned to the implement is limited by a border which can be used as an electrical conductor loop, and the implement recognizes the operating range by detecting signals from the conductor loop, wherein an additional, non-wired, external signal is used for controlling the implement.

### PRIOR ART

The invention is based on a method for recognizing the operating range of a mobile implement, particularly an automatically or semiautomatically operating ground treatment machine, according to the preamble of claim 1. The invention also relates to a system which operates on the basis of this method.

Automatically or semiautomatically operating ground treatment machines (e.g. lawnmowers) have been known for a long time. The operating area which cannot be left can be bounded by a current-carrying conductor. The resulting electrical or magnetic field can be detected by sensors on the traveling implement such that the appliance, on approaching the operating area boundary, turns or travels backwards, but in any case does not leave the operating area.

In a very simple embodiment, the boundary wire carries an electrical alternating current, and detection coils on the traveling implement are used to induce a voltage. Upon approaching the current-carrying conductor, the field strength increases significantly, and when a stipulated threshold is reached, a turn is made or the direction of travel is reversed.

(Bounding an operating area for traveling implements, inter alia: U.S. Pat. No. 3,550,714/U.S. Pat. No. 3,570,227 (both 1964); guiding a traveling appliance along a current-carrying conductor, inter alia: U.S. Ser. No. 549,674 (1940), U.S. Pat. No. 3,407,895 (1964), DE 1 613 991 (1968), DE 1 902 037 (1969)).

However, the great problem of these systems with signal strength measurement is that it is not possible to detect on what side of the current-carrying conductor the detection coil is situated, i.e. whether the implement is situated inside or outside the bounded operating area. A phase rotation/phase shift does indeed occur at the moment in which the border wire is crossed, but this phase shift cannot be detected statically, i.e. it is not possible to establish at any time whether the appliance is situated inside or outside the operating area.

These systems have been developed further in order to remedy this defect. By way of example, the border wire has been supplied with currents at 2 or more frequencies. If, by way of example, the frequencies are multiples of one another and the temporal relationship between them is known, the summed signal can be used to ascertain whether the implement is situated inside or outside the operating area (bounding operating area for traveling implements, inter alia: WO 90/00274 (1989), EP 1 025 472 (1998), EP 1 047 983 (1998); guiding a traveling appliance along a current-carrying conductor, inter alia: DE 2 228 659 (1972); general detection of the situation in relation to a current-carrying conductor, inter alia: U.S. Pat. No. 3,299,351 (1964), U.S. Pat. No. 5,438,266 (1993)).

EP 1 470 460 (2003) describes a system which has limited capability to detect whether the detection coil on a traveling implement is situated inside or outside a current-carrying boundary wire. To this end, the amplitude of the respective currently detected signals is compared with that of previous signals situated in a memory. A microprocessor performs numerical analysis in order to ascertain the number of measurements which are necessary in order to reach a threshold value and which are a measure of the distance from the boundary wire.

The results of the analysis are respectively stored in a memory cell and are available for a limited time (until the value in the memory cell is overwritten again). The sum total of the memory cells depicts the shape of the signal. Numerical analysis of the shape of the wave allows a phase change (when the border wire is crossed) to be detected. As a further option for detecting when the wire is crossed, mention is made of the option for the signals from two detection coils (e.g. at the front and rear of the vehicle) to be compared. This allows detection of a phase shift as a result of the wire being crossed at the front or rear.

The inside/outside information ascertained according to the aforementioned method is not constantly available (e.g. if the content of the memory cell is overwritten again or if the second coil has likewise crossed the wire).

EP 1 512 053 (2003) describes a system in which the boundary wire does not carry sinusoidal alternating currents but rather carries periodic, well defined current pulse trains. The first current pulse, which is received after a relatively long time phase without a signal, prompts triggering of the evaluation on the traveling implement. The current pulses converted into voltage signals are then subjected to time-based evaluation. Said current pulses can then be used to explicitly derive the information according to which the implement is situated inside or outside the bounded operating area.

EP 1 906 205 (2007) describes a similar method, in which the signal must contain at least one positive and a negative pulse inside a defined time interval.

All of the systems presented hitherto, which also allow the inside/outside association statically (i.e. when the implement is stationary, following deliberate repositioning of the implement or after the appliance has been switched on outside the operating area enclosed by the border wire), operate either with currents of two or more frequencies on the border wire or with current-pulse-triggered time-based evaluation of the signals on the wire.

EP 1 612 631 (2004) describes a system which can perform inside/outside evaluation without a current pulse trigger signal. However, this system has the absolute necessity that the implement be switched on inside the operating area. When the implement has been switched on, a clock on the implement is synchronized with the signal from the border wire. Following this synchronization, the implement keeps this synchronized time base and is able to detect phase changes as a result of the wire being crossed. Further synchronization operations between the internal clock and the signal on the border wire during the operating cycle are not envisaged. The signal on the border wire must be a clean sinusoidal signal at one frequency.

### OBJECT OF THE INVENTION

The object on which the invention is based is that of improving the method for localizing an operating area for an autonomous or semiautonomous implement.

### DISCLOSURE OF THE INVENTION

### Advantages of the Invention

The invention proposes achieving the localization of an operating area for an autonomous or semiautonomous implement through the combination of at least one signal, emitted by a conductor loop which bounds an operating area, with at least one radio signal delivering time information. This is achieved by means of time synchronization or reference to a common time base. It is therefore possible to detect at any time whether the implement is situated inside or outside the bounded operating area, this particularly also applying when the appliance is switched on outside the operating area.

In particular, methods for safely detecting the interior and exterior of the operating area are described.

The system according to the invention is used for localizing an operating area (AF) for a mobile autonomous or semiautonomous implement (AG). A system feature of this invention is the combination of signals emitted by one or more current-carrying conductor(s) with at least one further, wirelessly transmitted signal. This signal is required for synchronizing the signal evaluation and can be emitted
by the base station and any slave transmitters connected thereto,
by the implement,
by an external entity.

Further advantages of the invention are:

safe static detection of whether the implement is situated inside/outside the delimited operating area (i.e. works even when the implement is stationary or following deliberate repositioning of the implement or after the implement has been switched on outside the boundary of the operating area) little dependency on the field strength actually emitted by the current-carrying conductor (e.g. as a result of the wire being installed at different depths, different distances between the implement and the border wire)

low power consumption can be implemented when pulsed signals with a time limit are used on the bounding conductor loop (pulse principle).

In some variant embodiments, additional benefits such as an increase in the position-finding accuracy of the implement, simplification of the homing function (e.g. return of the appliances to the charging station), (possibly bidirectional) communication between charging station and implement (e.g. for the purpose of transmitting demands) are possible.

In some embodiments, the currents flowing through the bounding conductor loop do not need to contain components at multiple frequencies.

In some embodiments, the signals emitted by the bounding conductor loop do not necessarily need to be periodic and do not need to contain harmonic components.

In some embodiments, relatively simple evaluation electronics can be used.

In some embodiments, time-based evaluation is not imperative.

### DRAWING

The drawing shows exemplary embodiments or variants for the method according to the invention and a system according to the invention. The description, the associated figures and the claims contain numerous features in combination. A person skilled in the art will also consider these features, particularly also the features of different exemplary embodiments, individually and condense them into meaningful, further combinations.

In the drawing:

FIG. 1 shows system components for two variants A and B for the system according to the invention,

FIG. 2 shows a system according to the invention to clarify “inside” and “outside” for an operating area using a closed conductor loop (border wire),

FIG. 3 shows variants of the generation of the synchronization signal Sync,

FIG. 4 shows a possible component configuration on the implement (AG) in the system,

FIG. 5 shows signal trains MS to clarify the possible types of preprocessing for current signals on the border wire of the system,

FIG. 6 shows signal trains for generating the result signal ES1 from the measurement signal MS and the test signal TS,

FIG. 7 shows an illustration of the EVALUATION block for measuring the pulse duration of ES1,

FIG. 8 shows an illustration of the EVALUATION block for an alternative embodiment based on variant A2,

FIG. 9 shows signal trains for variant A1 for the measurement of the pulse duration of ES1 for a square-wave pulse train on the border wire,

FIG. 10 shows the system according to the invention in an alternative embodiment based on variant C1, in which a further participant initiates the emission of the border wire signal by SG and the measurement process on the AG at defined times,

FIG. 11 shows a schematic illustration of the operating area to clarify the arrangement of the transmitter of the Sync signal from the system according to the invention,

FIG. 12 shows a schematic illustration of an alternative operating area to clarify the improved arrangement of the transmitter of the Sync signal from the system according to the invention.

### DESCRIPTION OF THE EXEMPLARY EMBODIMENTS

The system presented here is used to localize an operating area (AF) for an autonomous or semiautonomous implement AG. A system feature of this invention is the combination of signals emitted by one or more current-carrying conductor(s) with at least one further, wirelessly transmitted signal.

The text below describes a few alternative options and variants of evaluation options for the two essential system components “wire signal” and “radio signal”.

This involves presenting a few options for evaluating these signals, but the invention is not limited to the cited circuit examples. It is also possible to use combinations of variants.

### Variant A

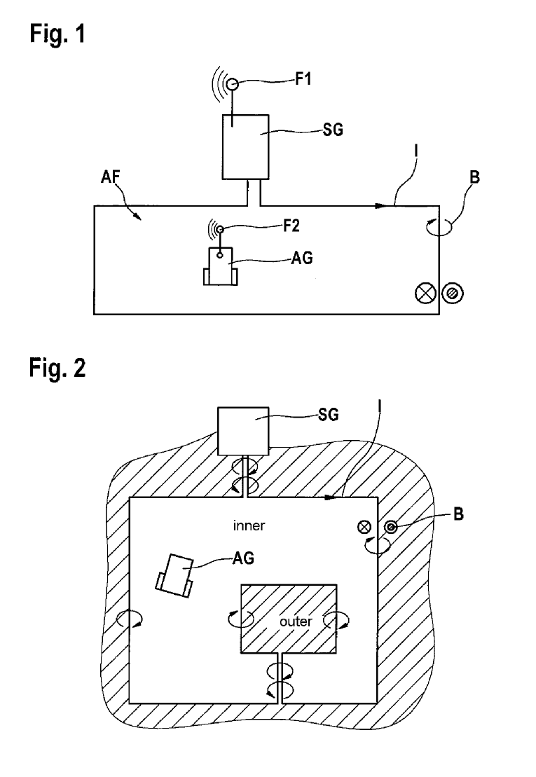

In variant A, the overall system (see FIG. 1) comprises:

At least one signal generator SG (typically integrated in the charging station) which generates a defined current system I and routes it through a closed conductor loop (border wire). Said closed conductor loop localizes an operating area AF which is to be treated such that the outside borders and any areas that are to be cut out (islands) are thereby explicitly defined. FIG. 2 clarifies the correlation by way of example. If traveling along the wire in the direction of flow shown, for example, the area to be treated is always to the right; on the left are the outside areas.

In addition, the signal generator SG has at least one radio interface F1 which can be used to broadcast a synchronization signal Sync.

An autonomous, mobile implement AG which has at least one radio interface F2, so that the synchronization signal Sync from the signal generator SG can be received.

The signal Sync is emitted in a fixed time reference in relation to the current signal I. By way of example, a sinusoidal current variable I could involve the Sync signal Sync being emitted at a zero crossing or the peak value. In the case of square-wave pulse, the Sync signal Sync could be emitted upon a rising edge.

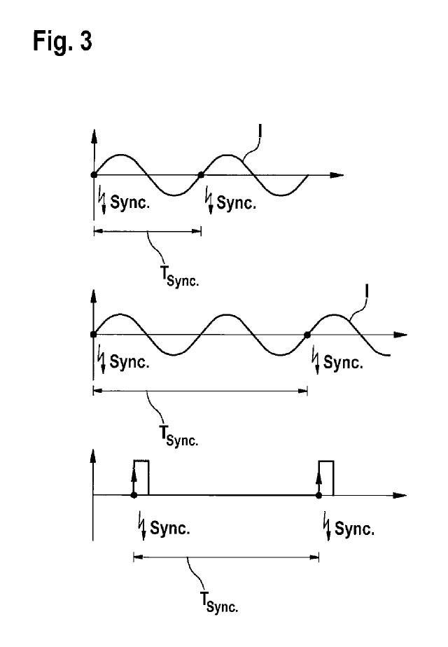

FIG. 3 provides some examples in this regard by showing variants of the generation of the synchronization signal Sync; in this case, Tsync indicates the period duration of the synchronization signal. It is advantageous if this is constant, this not being an imperative property, however.

FIG. 3 top: Sinusoidal signal and generation of the Sync signal Sync during the zero crossings from negative to positive. Without limiting the general nature, the signal could also arise for the zero crossings from positive to negative or upon every zero crossing.

FIG. 3 center: Sinusoidal signal and generation of the Sync signal Sync after a defined number of periods. In this example, after two full oscillation periods.

FIG. 3 bottom: Pulse current signal and generation of the Sync signal Sync on the rising edge of the signal.

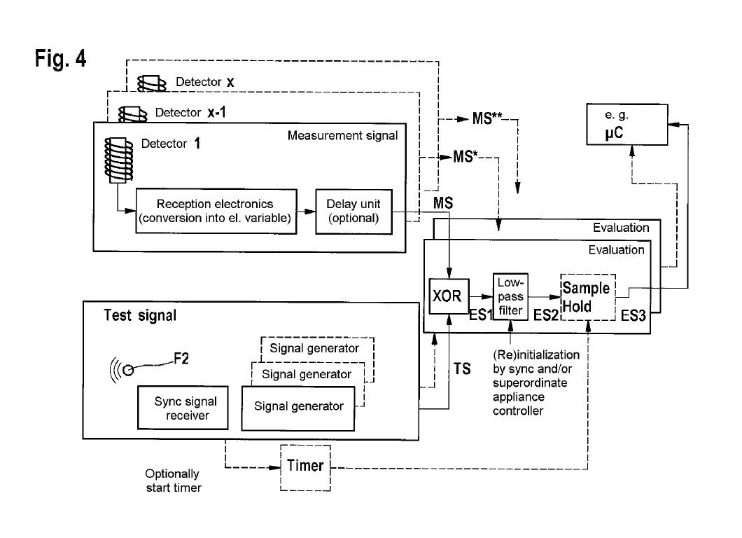

FIG. 4 shows some of the components on the implement AG which are needed for the signal evaluation, and also a possible component configuration on the implement AG. Components shown in dashes are optional or multiplications for extended variants. By way of example, the sample-and-hold element (Sample-Hold) could be integrated in the subordinate appliance control (e.g. μC).

BLOCK: MEASUREMENT SIGNAL: At least one detector (receiver coil with downstream electronics) which detects the magnetic field generated by the border wire signal and converts it into an electrical variable. Generally, more than one detector is used, e.g. in order to ascertain the angle of incidence of the AG when the boundary is transgressed. The components required for this purpose are multiplied accordingly.

BLOCK: TEST SIGNAL: A radio interface F2 with downstream signal conditioning (receiver) for detecting the synchronization signal Sync and also at least one signal generator which is triggered by the synchronization signal Sync and produces a defined test signal TS. The use of further signal generators which are triggered by the same synchronization signal Sync allows interference immunity to be increased, for example (with accordingly downstream evaluation electronics).

BLOCK: EVALAUTION: Evaluation electronics for recognizing the area (inside/outside) and forwarding it to superordinate appliance control, e.g. to a microcontroller μC. (Re)initialization of the evaluation electronics (e.g. resetting the low-pulse filter outward) can be performed by the synchronization signal Sync and/or the superordinate appliance controller. Similarly, some of the evaluation described can also be performed in the superordinate appliance controller.

Re MEASUREMENT SIGNAL BLOCK:

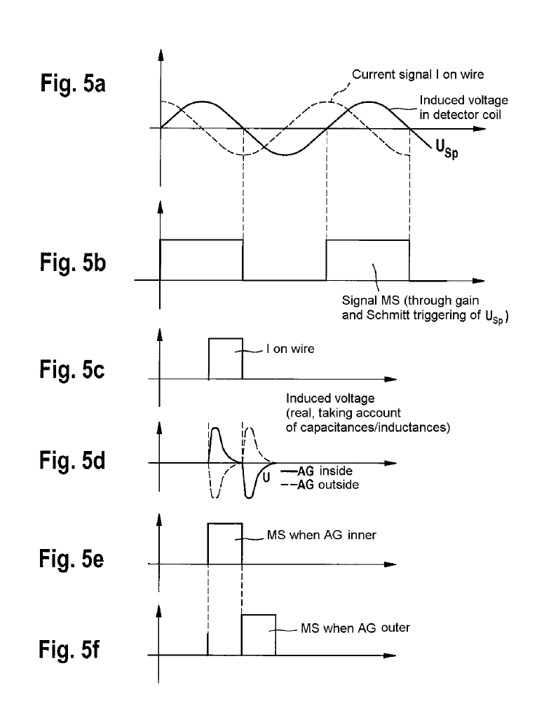

FIG. 5 shows possible types of preprocessing for current signals on the border wire.

FIG. 5 (a, b) shows a variant in which a sinusoidal current signal is evaluated by means of a coil and amplifier circuit with subsequent Schmitt triggering.

FIG. 5 (c-f) shows a variant in which a square-wave current pulse is evaluated by means of a coil and amplifier circuit with subsequent Schmitt triggering.

The result in all cases (sinusoidal signal/(square-wave) pulse signal/(square-wave) pulse train) is a square-wave output signal MS. In the case of the square-wave current pulse, it is possible to draw conclusions as to the received signal strength and hence to the distance from the wire from the pulse duration of the processed signal MS (decay response), given a suitable signal shape. The evaluation can be made by means of time-based measurement.

Re TEST SIGNAL BLOCK:

Optionally, the synchronization signal Sync can be used to start timers which start and/or end one or more measurement processes.

Re EVALUATION BLOCK

Variant A1 for the evaluation:

During the measurement process, the implement (AG) is used to generate at least one time-based test signal TS which is processed with the received and possibly further-processed border wire signal MS such that this can be used to recognize the polarity of the magnetic field explicitly and at any time and hence the inside/outside association descried above can be performed.

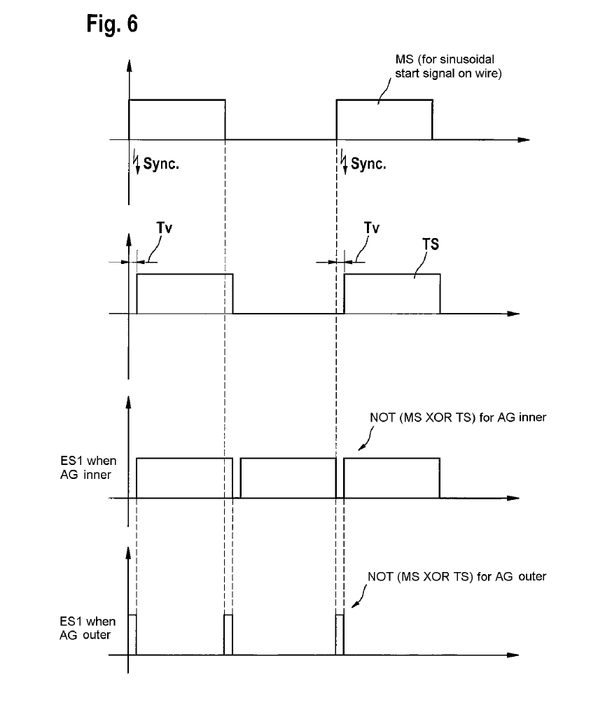

FIG. 6 shows an example of the use of a sinusoidal current signal on the wire, said current signal being converted into a square-wave function MS as described above. In addition, the signal TS produced on the AG is shown. In this example, this likewise involves a square-wave function with the same (known) period duration for the current signal. Ideally, MS and TS are identical in shape. Between the reception of the Sync signal Sync and the generation of TS, however, a sometimes variable delay time Tv may arise, but this is generally negligible in comparison with the remaining times. In the example shown, for the purpose of further processing, both signals are subjected to an Exclusive Or (XOR) Operation and then inverted to give the result signal ES1. Disregarding Tv, the value of a logic ‘1’ is always obtained when the AG is inside the operating area, and otherwise the value of a logic ‘0’ is obtained when the AG is situated outside the operating area. (These levels may also be defined inversely, depending on the direction of current flow or installation position or winding direction, etc.).

FIG. 6 shows the generation of the result signal ES1 from the measurement signal MS and the test signal TS, and also the effects when Tv is present. Downstream low-pass filtering produces ES2. It is now possible to define suitable threshold values which can be used to detect the two inside/outside states safely and explicitly.

As FIG. 4 shows (in the MEASUREMENT SIGNAL block), it is optionally possible to delay the received signal in the detector unit and hence to compensate Tv or possibly to set a desired delay Tv in a specific manner.

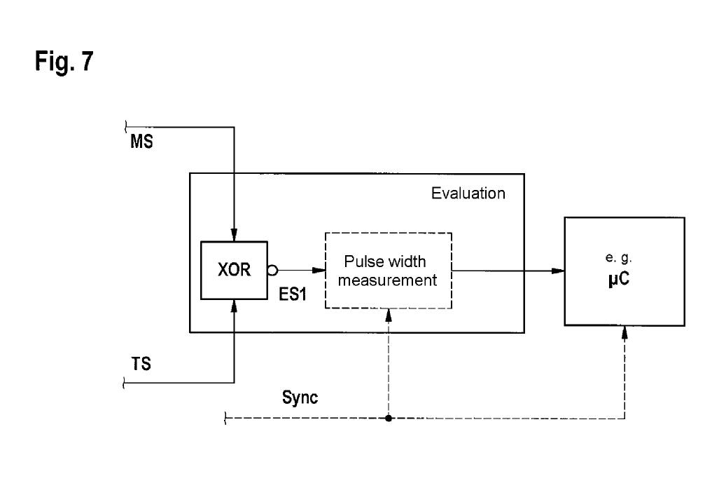

In the latter case, the evaluation can also be performed by measuring the pulse duration of ES1. To this end, the EVALUATION block shown in FIG. 7 needs to be performed. Besides dedicated electronics for pulse width measurement, it is also possible for a superordinate appliance controller to do this directly (e.g. μC, in FIG. 7 as shown, the “pulse width measurement” block would be dispensed with). Optionally, the Sync signal Sync can be used to trigger the measurement at particular times (shown in dashes in FIG. 7).

Variant A2 for the evaluation:

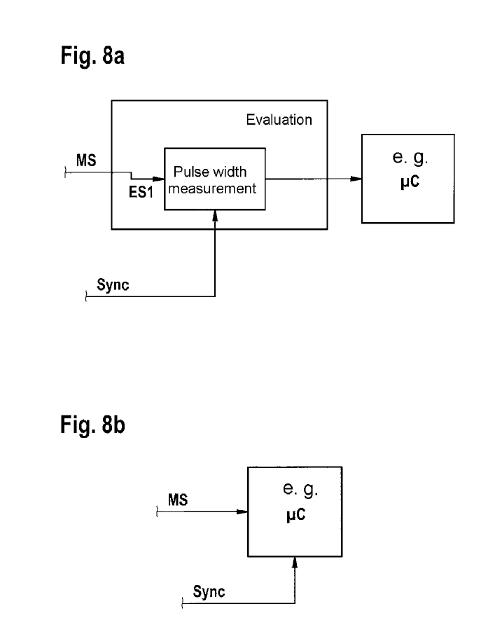

A further embodiment does not require a test signal TS and the pulse width evaluation of the measurement signal MS takes place directly. In this case, the triggering by the Sync signal Sync is absolutely essential as a time reference (see FIG. 8a).

As FIG. 8b shows, the pulse width evaluation can be performed by a dedicated electronics unit or directly by a superordinate appliance controller (e.g. μC).

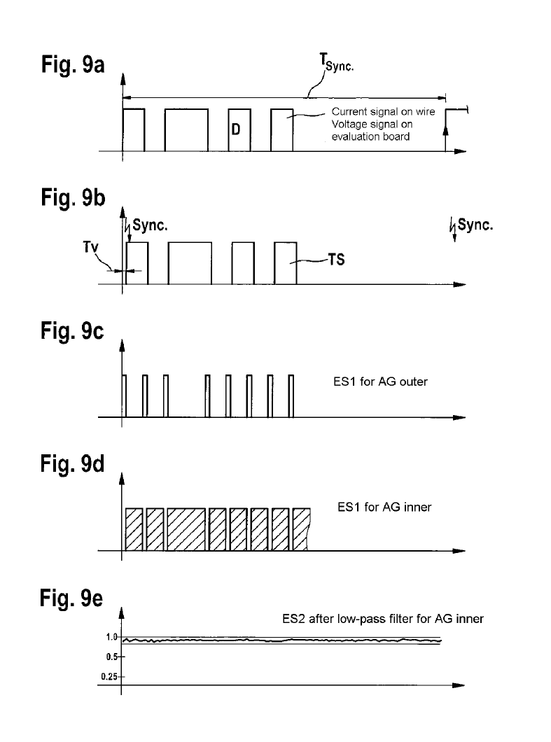

FIG. 9 shows a further refinement of variant A1, in which a square-wave pulse train is used on the wire. In this case, it is advantageous to use a specific pattern (e.g. in the form of a pseudo-binary signal) so as to perform encoding (interference immunity, use of multiple appliances, theft prevention), for example. Available evaluation options are the methods described above.

Variant A3 for the evaluation:

In a further embodiment which is shown in FIG. 4, the implement AG does not have any test signals TS generated on it and the measurement process is performed at discrete times. To this end, the timer shown is activated by the Sync signal Sync and, after one or more defined time periods have elapsed, triggers the sampling of the signal MS and stores it in ES3 for further processing, e.g. by a μC. The timer function can also be undertaken by the μC.

### Variant B

In the case of variant B, the autonomous implement AG emits the synchronization signal. In this case, Sync signal detection takes place on the signal generator SG. Immediately or after a defined delay, a defined border wire signal is then emitted. This time is known to the AG, which means that the signal evaluation variants described above, i.e. correlation for the separately generated signal on the AG or defined sampling of the converted border wire signal can be used.

### Variant C

In the case of variant C, both the signal generator and the autonomous implement AG have their timing synchronized by a third entity.

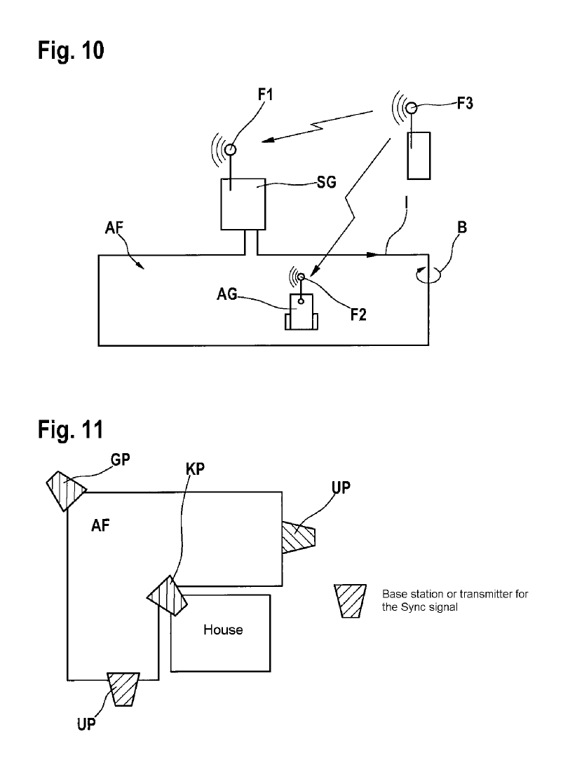

In the case of version C1 of variant C, this is done by at least one further participant F3 in the radio communication which initiates the emission of the border wire signal and the measurement process on the AG at defined times. The inside/outside evaluation can take place as described above. (FIG. 10). In the indoor domain, this can be done be resorting to existing networks such as LAN or pager systems, for example.

In the case of version C2 of variant C, both the signal generator and the autonomous implement have the same time base by virtue of their both having a GPS receiver or a radio clock receiver (e.g. DCF77), for example. If appropriate, time correction for the local clocks running on the SG and the AG takes place with sufficient frequency. At well defined times in the global time base (controlled by the local clocks), the border wire signal is emitted and the signal evaluation is started on the AG.

There is an additional benefit if both the signal generator SG and the implement AG are equipped with a GPS module: the system can be implemented as a differential GPS system (DGPS), which provides improved position-finding information (more precise local position finding and speed measurement for the AG possible). The correction data required for calculating the more precise information can be transmitted from the signal generator SG to the implement AG in encoded form by means of the border wire signal.

### Variant D

The signal generator SG merely produces a simple current pulse or a current pulse train, which does not necessarily need to be repeated in a fixed period. At the same time, SG emits the Sync signal, which immediately initiates a measurement and evaluation process for the current pulse/the current pulse train on the AG.

### Variant E

(One or more slave transmitters for complete transmission coverage of the operating area are used):

Variants A and B require wireless communication between SG and AG (unidirectional or bidirectional). Shapes of operating areas AF are conceivable in which portions of the operating area are thrown into shadow by obstacles (e.g. house, garage). The position of the transmitter for the Sync signal (usually the base station) then needs to be chosen such that communication with the AG is assured in all regions of the operating area.

FIG. 11 illustrates this using the example of an L-shaped operating area AF and the possible position of the transmitter of the Sync signal for variants A and B (GP: suitable positioning, KP: possibly critical positioning, UP: possibly unsuitable positioning).

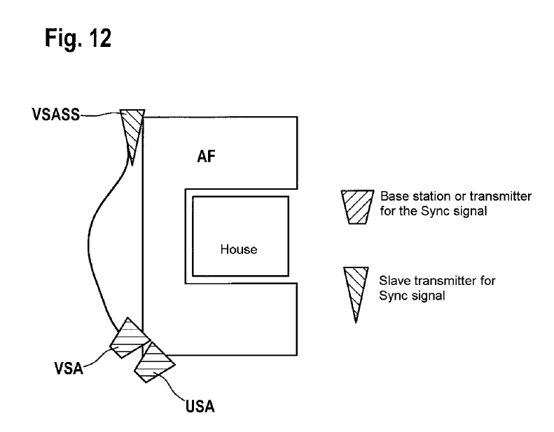

FIG. 12 shows a C-shaped operating area AF and the transmission coverage for the Sync signal for this specially shaped operating area AF for variants A and B (VSA: complete transmission coverage, USA: possibly incomplete transmission coverage for the operating area). In this context, it may no longer be possible to produce complete transmission coverage with just one transmitter. In this case, it is necessary to use at least one slave (secondary) transmitter VSASS, which can transmit into the areas which are not able to be covered by the master transmitter. This slave transmitter VSASS may be connected to the master transmitter either by means of a line or wirelessly (repeater).

Further embodiments:

The method according to the invention and the system according to the invention for recognizing the operating area of a mobile implement are not limited to the embodiments described above.

In the above explanations, reference is usually made to an autonomous implement AG. Alternatively, a boundary system of the type described can be used for operating a semiautonomous implement. This may be a manually pushed lawnmower, for example, which switches off the mower mechanism as soon as the detector on the appliance crosses the boundary wire.

Relates to current pulses on the conductor loop which bounds the operating area: choice of sinusoid or pulse shape:
sinusoid is typically low current in order to have low losses;
   advantage: attuned LC resonant circuit on reception unit possible, provides additional gain for the signal.
pulses require relatively high individual current levels, but the power draw can likewise be kept low using small pulse widths in relation to period duration of the signal.

Current signals on the conductor loop which bounds the operating area may include one or more of the following characteristics:
may be sinusoidal
may be pulse trains
may also be triangular or sawtooth in shape, for example
may include a positive and/or negative component
may include a DC component
may include multiple frequencies (but do not have to)
do not necessarily have to be at a fixed frequency
may have different amplitudes.

The radio signals described above may also be in encoded form, e.g. using amplitude modulation, which results in an increase in interference immunity.

The wireless communication described above can take place, for example, by means of: radio, Bluetooth, infrared, laser, Wi-Fi.

Additional functions to radio communication: transmission of further information, e.g. sending of commands such as “Return to base station”.

Apart from the purpose of localizing operating areas, a system as described above can also be used for guiding mobile (autonomous or semiautonomous) appliances (tracking the wire).

A boundary system as explained above can also be used for the following tasks, for example (this listing is not complete):
ground treatment tasks in the open air, such as lawn mowing, lawn thatching, aeration, foliage collection, garden irrigation, garden/lawn fertilization, snow clearance
floor treatment tasks indoors in a home, such as vacuum cleaning, floor wiping/washing/polishing
floor treatment tasks indoors in the public/industrial domain, such as preparation of ice surfaces (for skating), floor vacuum cleaning/wiping/washing/polishing, e.g. in sports and multipurpose halls or in industrial halls and stores
generally for the localization of areas of residence for mobile appliances such as semiautonomous and fully autonomous appliances (robots).

A boundary system of the following kind can also be used for nonautonomous or semiautonomous appliances:
“a virtual fence”, e.g. for dogs/cats/small animals (detector in dog collar)
theft prevention (e.g. for vehicles or appliances from company sites, trial vehicles from test sites, cross country vehicles from offroad routes, weapons from shooting ranges, etc.)
as an “electronic tag”.

1. A method for recognizing the operating range of a mobile, autonomous implement, in which the operating range assigned to the implement is limited by a border which can be used as an electrical conductor loop, and the implement recognizes the operating range by detecting signals from the conductor loop, wherein an additional, non-wired, external signal is used for controlling the implement.

2. The method as claimed in claim 1, wherein the at least one external signal is emitted in a fixed time reference with respect to a signal I, particularly a current signal, which is applied to the electrical conductor loop.

3. The method as claimed in claim 1, wherein the at least one external signal is used for synchronizing detection by the implement, particularly for synchronizing signal evaluation by the implement for the purpose of detecting the border.

4. The method as claimed in claim 1, wherein the at least one additional external signal is emitted by a base station, particularly by a fixed base station, for the purpose of producing the signal I to be applied to the electrical conductor loop.

5. The method as claimed in claim 4, wherein the base station is in the form of a charging station for one or more energy stores driving the implement.

6. The method as claimed in claim 1, wherein the at least one external signal is detected by an interface of the implement.

7. The method as claimed in claim 3, wherein a test signal is generated which is processed with a processed or unprocessed signal from the conductor loop in order to determine the polarity of the magnetic field from the conductor loop.

8. The method as claimed in claim 3, wherein pulse evaluation of a processed or unprocessed signal from the conductor loop is performed in order to determine the polarity of the magnetic field from the conductor loop.

9. The method as claimed in claim 2, wherein the at least one external signal is emitted by the implement which is to be controlled.

10. The method as claimed in claim 9, wherein the at least one external signal is detected by a signal generator for the purpose of producing signals for the conductor loop.

11. The method as claimed in claim 9, wherein the signal I which is to be applied to the electrical conductor loop is sent in temporally defined form in relation to the at least one external signal.

12. The method as claimed in claim 2, wherein the at least one additional external signal is emitted by an external device.

13. The method as claimed in claim 12, wherein the external device sends a non-wired signal for the purpose of synchronizing the emission of the signal I which is to be applied to electrical conductor loop and a detection process for a processed or unprocessed signal from the conductor loop by the implement.

14. The method as claimed in claim 11, wherein a signal generator for applying a signal I to the electrical conductor loop and the implement have the same time base.

15. The method as claimed in claim 1, wherein the at least one external signal is transmitted by means of transmitters and/or slave transmitters.

16. The method as claimed in claim 1, wherein the conductor loop has a pulsed or continuous signal, particularly a continuous sine/cosine signal, applied to it.

17. The method as claimed in claim 1, wherein the conductor loop has an amplitude- or frequency-modulated signal applied to it.

18. A system for recognizing the operating range of a mobile implement, having at least one border which can be used as an electrical conductor loop, a signal generator for producing a signal for the conductor loop and an autonomous or semi-autonomous, mobile implement with a radio interface, wherein at least one further radio interface is provided which can be used to interchange a synchronization signal between the signal generator and the implement.
